(19) United States
(12) Patent Application Publication
(10) Pub. No.: US 2006/0268374 A1
(43) Pub. Date: Nov. 30, 2006

(54) Position control device, and scanner and image forming apparatus having the same

(75) Inventor: Tae-young Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/433,398

(22) Filed: May 15, 2006

(30) Foreign Application Priority Data
May 24, 2005 (KR) 10-2005-0043659

(51) Int. Cl. H04N 1/04

(52) U.S. Cl. 358/497; 358/486

(57) ABSTRACT

A position control device is provided for controlling a velocity and position of a moving body or a rotating body such as a print head, scanning module, and so forth, and providing a scanner and an image forming apparatus having at least one of such position control devices. The position control device comprises an encoding unit having a color chart on which colors are indicated, a sensing unit for detecting the colors indicated on the color chart, and a control unit for determining the velocity and position of the rotating body or the moving body and controlling the driving of the motor on the basis of detected colors. According to embodiments of the present invention, because the velocity and position are controlled on the basis of values of respective colors detected by the sensing unit, it is possible to control the velocity and position of the rotating body or the moving body substantially as accurately as the resolution of the sensing unit for detecting the colors, and also correctly control the velocity and position substantially without any error even if the rotating body or the moving body slips.

### CROSS-REFERENCE TO RELATED APPLICATIONS

This application claims the benefit under 35 U.S.C. §119(a) of Korean Patent Application No. 10-2005-0043659 filed in the Korean Intellectual Property Office on May 24, 2005, the entire disclosure of which is hereby incorporated by reference.

### BACKGROUND OF THE INVENTION

1. Field of the Invention

The present invention relates to a position control device for controlling a velocity and position of a moving body or a rotating body in an image forming apparatus. More specifically, the present invention relates to a position control device for controlling a velocity and position of a moving or rotating body, such as a print head for printing an image on a paper or a scanning module for scanning data from a document, and a scanner and an image forming apparatus having such a position control device.

2. Description of the Related Art

Recently, in order to improve office efficiency and to realize office automation, image forming apparatuses which can collectively implement various functions, for example, functions of a copying machine/printer or a copying machine/facsimile/printer, have become widely used. A representative example of such an image forming apparatus is an ink-jet composite machine including both copying and printing functions.

FIGS. 1 and 2 illustrate a conventional ink-jet composite machine 1 including both scanning and printing functions.

The ink-jet composite machine 1 comprises a scanner unit 10 for performing a copying function, and a printer unit 30 for performing a printing function.

The scanner unit 10 is a flat-bed type scanner, which has a scanning module 13 for scanning data from a document (not shown).

FIG. 3 is a partial cross-sectional view of the scanner unit of the composite machine shown in FIG. 1. As shown in FIG. 3, the scanning module 13 is secured to a module conveying belt 16. The module conveying belt 16 is driven by a drive pulley 21 to convey the scanning module 13 left and right. The drive pulley 21 is provided coaxial to a drive pulley gear 20, which is meshed with a drive gear 18 formed on a drive shaft 19 of a scanner motor 17.

In order to control a conveying velocity and position of the scanning module 13, the scanner unit 10 further comprises scanning module position control means 40.

FIG. 4 is a partial perspective view of the scanner module position control means of the scanner unit shown in FIG. 3. As shown in FIG. 4, the scanning module position control means 40 comprises a circular encoding film 43, a first photo interrupt sensor 46, and a microprocessor (not shown).

The circular encoding film 43 is secured to the drive shaft 19 of the scanner motor 17, and is comprised of opaque parts 44 and transparent parts 45 that are alternately and repeatedly formed in the encoding film 43.

FIGS. 5A and 5B are, respectively, a cross-sectional view of the scanner module position control means shown in FIG. 4 and a diagram showing waveforms generated in first and second light reception parts of the scanner module position control means. Referring to FIG. 5A, the first photo interrupt sensor 46 comprises a light emission part L and first and second light reception parts X and Y, which are positioned at opposite sides of the circular encoding film 43 to face one another. As shown in FIGS. 5A and 5B, the first and second light reception parts X and Y are arranged in the peripheral direction along the rotating direction of the circular encoding film 43 with a predetermined interval being provided between them so that they produce pulses having a phase difference of a given angle, for example, 90°. Therefore, when the circular encoding film 43 is rotated by the scanner motor 17, the light emission part L emits light to the circular encoding film 43 and the first and second light reception parts X and Y sense the transmitted light via the transparent parts 45 between the opaque parts 44 in the circular encoding film 43, thereby generating pulses.

The microprocessor determines the position and velocity of the scanning module 13 based on the number and time interval of the pulses, and controls the driving of the scanner motor 17 through a motor drive circuit (not shown). In addition, the microprocessor determines which of the first and second light reception parts X and Y first generates a pulse to determine the moving direction of the scanning module 13.

As shown in FIG. 2, the printer unit 30 comprises a carriage 34 on which at least one ink cartridge 34a having a print head for printing an image on a paper is mounted. The carriage 34 is conveyed left and right through a conveying belt 35 (see FIG. 6) driven by a carriage motor (not shown).

In order to control the position and conveying velocity of the print head of the ink cartridge 34a mounted on the carriage 34, the printer unit 30 further comprises a print head position control means 50 as shown in FIG. 6. FIG. 6 is a partial perspective view illustrating the print head position control means of the printer unit of the composite machine shown in FIG. 1.

The print head position control means 50 comprises a linear encoding strip 51, a second photo interrupt sensor 54, and a microprocessor (not shown).

The linear encoding strip 51 is mounted on a frame 36 along the moving direction of the carriage 34 behind the carriage 34, in which plural slits 52 are repeatedly formed in the linear encoding strip 51 with a predetermined interval being provided between each two adjacent slits.

The second photo interrupt sensor 54 is secured to the rear side of the carriage 34 so that the second photo interrupt sensor 54 can be moved along with the carriage 34, wherein the second photo interrupt sensor 54 has a light emission part and first and second light reception parts, which are arranged on the opposite sides of the linear encoding strip 51 to face one another. When the second photo interrupt sensor 54 is moved by the carriage 34, the light emission part emits light onto the linear encoding strip 51, and the first and second light reception parts sense the light transmitted via the slits 52 of the linear encoding strip 51, thereby generating pulses.

The microprocessor determines the position and velocity of the print head of the ink cartridge 34a based on the number and time interval of the pulses generated by the second photo interrupt sensor 54 substantially as with the first interrupt sensor 46, and controls the driving of the carriage motor through a motor drive circuit. In addition, the microprocessor determines which of the first and second light reception parts first generates a pulse to determine the moving direction of the carriage 34.

However, the conventional ink-jet composite machine 1 configured as described above has at least one problem in that the accuracy in controlling the positions and conveying velocities of the scanning module 13 and the print head are limited depending on an interval between each two adjacent transparent parts 45 (hereinafter, referred as “inter-transparency interval”) formed on the circular encoding film 43, and an interval between each two adjacent slits 52 (hereinafter, referred as “inter-slit interval”) formed on the linear encoding strip 51. This results because the transparent parts 45 of the circular encoding film 43 and the slits 52 of the linear encoding strip 51 are arranged in such a way that the moving distances, that is, the positions of the scanning module 13 and the print heads of the ink cartridges 34a, are determined by counting the number of the pulses detected by the first and second photo interrupt sensors 46 and 54, and the conveying velocities of the scanning module 13 and the print head are determined on the basis of the time interval of the detected pulses.

More specifically, the first or second photo interrupt sensor 46 or 54 generates a pulse each time corresponding to the inter-transparency interval in the circular encoding film 43 or the inter-slit interval in the linear encoding strip 51. Therefore, when one point is scanned from a document or printed on a paper, if the light emission part and the first and second light reception parts of the first or second photo interrupt sensor 46 or 54 are passing an opaque part 44 in the circular encoding film 43 or an opaque part 53 in the linear encoding strip 51 at an instant when the scanning module 13 scans one point on the document or the print head prints at one point on the paper, the first or second photo interrupt sensor 46 or 54 does not generate a pulse during the time period corresponding to a width or an interval of the opaque part 44 or 53 (hereinafter, referred to as “opaque interval”). Therefore, the microprocessor can calculate the position of the scanning module 13 or the print head, not on the basis of the time point when the first or second photo interrupt sensor 46 or 54 is positioned on the opaque part 44 or 53, but on the basis of the time point when the first or second photo interrupt sensor 46 or 54 generates a pulse on a transparent part 45 or slit 52 positioned before and after the opaque part 44 or 53. Therefore, in this situation an error in position occurs when the scanning module 13 scans the one point on the document or the print head prints at the one point on the paper, by a distance corresponding to the opaque interval. As a result, the resolution in the quality of image to be scanned or printed will be deteriorated.

In addition, according to the conventional ink-jet composite machine 1, the circular encoding film 43 and the linear encoding strip 51, each has a format in which the opaque parts 44 and transparent parts 45, and the opaque parts 53 and slits 52, are respectively each formed having the same shape and are repeatedly arranged in the same pattern. Therefore, if any of the conveying belt 16, the carriage conveying belt 35, and so forth, mechanically slip, the first and second photo interrupt sensors 46 and 54 skip over the transparent sections 45 and slits 52 by the slipped distance without detecting them. In this case, a measuring error is caused in the positions and conveying velocities of the scanning module 13 and the print head by the slipped distance, and as a result of which, the quality of the scanned and printed image will be deteriorated.

In addition, because the transparent parts 45 of the circular encoding film 43 and the slits 52 of the linear encoding strip 51 are respectively each formed having the same shape and are repeated in the same pattern, the microprocessor cannot determine the positions of the scanning module 13 and the print head on the basis of only a pulse generated by one transparent part 45 or one slit 52 from the first and second photo interrupt sensors 46 and 54. Therefore, when the power source of the composite machine 1 is first turned “ON”, the microprocessor requires a procedure for initializing the positions of the scanning module 13 and the print head to correct the change in position of the scanning module 13 and the print head in a state in which the power source of the composite machine 1 is turned “OFF”. Such an initializing procedure requires moving the scanning module 13 and the print head left and right along the entire conveying path, thereby contributing to the delays of printing time.

Accordingly, a need exists for a system and method to prevent the deterioration in quality of scanning and printed image and/or the delay of printing time as mentioned above. In doing so, a need exists for a position control device for a scanning module and/or a print head, which can avoid a measuring error caused by an inter-transparency interval in the circular encoding film 43 and/or by the inter-slit interval in the linear encoding strips 51 and the deterioration in quality of scanning and printing thereby, and further avoid a measuring error caused as a result of the transparent parts 45 and 53 being respectively each formed in the same shape and repeated in the same pattern and the deterioration in quality of scanning and printing and/or the delay of printing time caused thereby.

### SUMMARY OF THE INVENTION

Accordingly, embodiments of the present invention have been made to substantially solve the above-mentioned and other problems, and an object of embodiments of the present invention is to provide a position control device which can correctly and precisely control a velocity and position of a moving body or a rotating body such as a print head, a scanning module, and so forth, without substantially any measuring error, and a scanner and image forming apparatus having such a position control device.

Another object of embodiments of the present invention is to provide a position control device which can control a velocity and position of a moving body or a rotating body such as a print head, a scanning module, and so forth, without an initializing procedure of the velocity and position, and a scanner and image forming apparatus having such a position control device.

In order to achieve the above-mentioned objects, according to an aspect of embodiments of the present invention, a position control device is provided for controlling a velocity and position of a rotating body or a moving body driven by a motor, wherein the position control device comprises an encoding means having a color chart on which colors are indicated, a sensing means for detecting the colors indicated on the color chart, and a control means for determining the velocity and position of the rotating body or the moving body and controlling the driving of the motor.

Here, the encoding means may comprise a circular plate or a linear strip.

In addition, the color chart of the encoding means may be configured in a format in which plural colors are arranged in such a way that the colors are gradually changed in sequence or in a format in which plural colors are each formed in a band shape and the bands are arranged in sequence. In particular, it is preferable that an interval between two adjacent colors (hereinafter, referred to as “inter-color interval”) is set within a range of resolution that allows the sensing means to detect each color.

The sensing means may comprise a color sensor or an image sensor.

Alternatively, the sensing means may comprise a lamp for illuminating light on the color chart of the encoding means, at least one mirror for reflecting the light reflected from the color chart, a lens for focusing the light reflected by the mirror, and a charge coupled device (CCD) sensor for detecting light focused by the lens.

The control means may comprise an image processing circuit for converting a signal into a red, green and blue (R,G,B) value, in which the signal is generated when the sensing means detects a color, a microprocessor for determining the velocity and position of the rotating body or the moving body corresponding to each color on the basis of the R,G,B values of respective colors converted by the image processing circuit, and a motor drive circuit for controlling the motor under the control of the microprocessor.

According to another aspect of embodiments of the present invention, a scanner is provided comprising a scanning module for scanning data from a document, a motor for generating a drive force for conveying the scanning module, and a scanning module position control means for controlling the conveying velocity and position of the scanning module. The scanning module position control means comprises an encoding means arranged on a conveying path of the scanning module to face the scanning module and having a color chart on which colors are indicated, and a control means for determining the conveying velocity and position of the scanning module on the basis of the data of colors detected by the scanning module when the scanning module is conveyed, and controlling the driving of the motor.

Here, the encoding means may comprise at least one linear strip arranged along the moving path of the scanning module.

In addition, the color chart of the encoding means may be configured in a format in which plural colors are arranged in such a way that the colors are gradually changed in sequence or in a format in which plural colors are each formed in a band shape and the bands are arranged in sequence. In particular, it is preferable that an inter-color interval is set within a range of resolution that allows the scanning module to detect each color.

The scanning module may comprise a lamp for illuminating light on the document and the color chart of the encoding means, at least one mirror for reflecting the light reflected from the document and the color chart, a lens for focusing the light reflected by the mirror, and a CCD sensor for detecting light focused by the lens.

The control means may comprise an image processing circuit for converting a signal into an R,G,B value, in which the signal is generated when the sensing means detects a color, a microprocessor for determining the conveying velocity and position of the scanning module corresponding to each color on the basis of the R,G,B values converted by the image processing circuit, and a motor drive circuit for controlling the motor under the control of the microprocessor.

According to another aspect of embodiments of the present invention, an image forming apparatus is provided comprising a carriage for conveying at least one ink cartridge mounted thereon and having a print head for printing an image on a paper, a carriage driving means having a first motor for generating a driving force for conveying the carriage, and a printer unit having a first position control means for controlling the conveying velocity and position of the print head of the ink cartridge mounted on the carriage conveyed by the first motor. The first position control means comprises a second encoding means having a color chart on which colors are indicated, a first sensing means for detecting the colors indicated on the color chart, and a control means for determining the position and conveying velocity of the print head on the basis of the colors detected by the first sensing means, and controlling the driving of the first motor.

Here, the second encoding means may comprise a linear strip arranged on a frame along the conveying path of the carriage.

The color chart of the second encoding means may be configured in a format in which plural colors are arranged in such a way that the colors are gradually changed in sequence or in a format in which plural colors are each formed in a band shape and the bands are arranged in sequence. In particular, it is preferable that an inter-color interval is set within a range of resolution that allows the first sensing means to detect each color.

The first sensing means may comprise a color sensor or an image sensor arranged on the carriage to face the second encoding means and to be moved along with the carriage.

The control means may comprise an image processing circuit for converting a signal into an R,G,B value, in which the signal is generated when the first sensing means detects a color, a microprocessor for determining the conveying velocity and position of the print head corresponding to each color on the basis of the R,G,B values converted by the image processing circuit, and a motor drive circuit for controlling the driving of the first motor under the control of the microprocessor.

The printer unit according to an exemplary embodiment of the present invention may further comprise at least one paper-feeding roller for conveying a paper, a second motor for providing a driving force for driving the paper-feeding roller, and a second position control means for controlling the rotating velocity of the second motor.

The second position control means may comprise a third encoding means having a color chart on which colors are indicated, a second sensing means for detecting the colors indicated on the third encoding means, and a control means for determining the rotating velocity of the paper-feeding roller on the basis of the colors detected by the second sensing means, and controlling the driving of the second motor.

The third encoding means may comprise a circular plate mounted on a drive shaft of the second motor or a shaft of a gear driven by the second motor.

In addition, the color chart of the third encoding means may be configured in a format in which plural colors are arranged in such a way that the colors are gradually changed in sequence, or in a format in which plural colors are each formed in a band shape and the bands are arranged in sequence. In particular, it is preferable that an inter-color interval is set within a range of resolution that allows the second sensing means to detect respective colors.

The second sensing means may comprise a color sensor or an image sensor mounted on a frame to face the third encoding means.

The control means may comprise an image processing circuit for converting a signal into an R,G,B value, in which the signal is generated when the second sensing means detects a color, a microprocessor for determining the rotating velocity of the paper-feeding roller corresponding each color on the basis of the R,G,B values calculated by the image processing circuit, and a motor drive circuit for controlling the driving of the second motor under the control of the microprocessor.

The inventive image forming apparatus may further comprise a scanning unit for scanning data from a document.

The scanning unit may comprise a scanning module for scanning data from the document, a third motor for generating a driving force for conveying the scanning module, and a third position control means for controlling the conveying velocity and position of the scanning module. The third position control means comprises a first encoding means arranged on the conveying path of the scanning module to face the scanning module and having a color chart on which colors are indicated, and a control means for determining the conveying velocity and position of the scanning module on the basis of the data of the colors on the color chart detected by the scanning module when the scanning module is conveyed, and controlling the driving of the third motor.

Here, the first encoding means may comprise at least one strip arranged along the moving path of the scanning module.

In addition, the color chart of the first encoding means may be configured in a format in which plural colors are arranged in such a way that the colors are gradually changed in sequence, or in a format in which plural colors are each formed in a band shape and the bands are arranged in sequence. In particular, it is preferable that an inter-color interval is set within a range of resolution that allows the scanning module to detect respective colors.

The scanning module may comprise a lamp for illuminating light on a document and the color chart of the encoding means, at least one mirror for reflecting the light reflected from the document and the color chart, a lens for focusing the light reflected by the mirror, and a CCD sensor for detecting light focused by the lens.

The control means may comprise an image processing circuit for converting a signal into an R,G,B value, in which the signal is generated when the sensing means detects a color, a microprocessor for determining the conveying velocity and position of the scanning module corresponding to respective colors on the basis of the R,G,B values converted by the image processing circuit, and a motor drive circuit for controlling the third motor under the control of the microprocessor.

### BRIEF DESCRIPTION OF THE DRAWINGS

The patent or application file contains at least one drawing executed in color. Copies of this patent or patent application publication with color drawings will be provided by the Office upon request and payment of the necessary fee. The above aspects and features of exemplary embodiments of the present invention will become more apparent from the following description taken with reference to the accompanying drawings, in which:

FIGS. 1 and 2 are perspective views of a conventional ink-jet composite machine;

FIG. 3 is a partial cross-sectional view of a scanner unit of the composite machine shown in FIG. 1;

FIG. 4 is a partial perspective view of a scanner module position control means of the scanner unit shown in FIG. 3;

FIGS. 5A and 5B are, respectively, a cross-sectional view of the scanner module position control means shown in FIG. 4 and a diagram showing waveforms generated in first and second light reception parts of the scanner module position control means;

FIG. 6 is a partial perspective view illustrating a print head position control means of the printer unit of the composite machine shown in FIG. 1;

FIGS. 7 and 8 are perspective views of exemplary ink-jet composite machines to which a position control device is applied in accordance with an embodiment of the present invention;

FIG. 9 is a block diagram of an exemplary control means of the ink-jet composite machine shown in FIG. 7 in accordance with an embodiment of the present invention;

FIG. 10 is a top plan view of an exemplary scanner unit of the ink-jet composite machine shown in FIG. 7 in accordance with an embodiment of the present invention;

FIG. 11 is a cross-sectional view taken along line I-I of FIG.10;

FIGS. 12A, 12B and 12C are top plan views exemplifying examples of color charts of a first encoding means of the scanner module position control device of the scanner unit shown in FIG. 7 in accordance with an embodiment of the present invention;

FIG. 13 is a partial perspective view of an exemplary print unit of the ink-jet composite machine shown in FIG. 7 in accordance with an embodiment of the present invention;

FIG. 14 is a perspective view of an exemplary carriage drive means and paper-feeding roller drive means of the printer unit shown in FIG. 13 in accordance with an embodiment of the present invention;

FIG. 15 is a partial perspective view illustrating an exemplary print head position control device of the printer unit shown in FIG. 13 in accordance with an embodiment of the present invention;

FIG. 16 is a partial perspective view illustrating a second sensing means and a third encoding means of the paper-feeding roller position control device of the printer unit shown in FIG. 13 in accordance with an embodiment of the present invention;

FIGS. 17A, 17B, and 17C are top plan views exemplifying color charts of the third encoding means of the paper-feeding roller position control device shown in FIG. 16 in accordance with an embodiment of the present invention;

FIG. 18 is a top plan view exemplifying another example of the first encoding means of the scanner module position control device of the scanner unit shown in FIG. 7 in accordance with an embodiment of the present invention; and

FIG. 19 is a top plan view exemplifying forms of first and second linear strips of the first encoding means shown in FIG. 18 in accordance with an embodiment of the present invention.

Throughout the drawings, like reference numerals will be understood to refer to like parts, components and structures.

### DETAILED DESCRIPTION OF EXEMPLARY EMBODIMENTS

Hereinbelow, exemplary embodiments of the present invention are described in detail with reference to accompanying drawings.

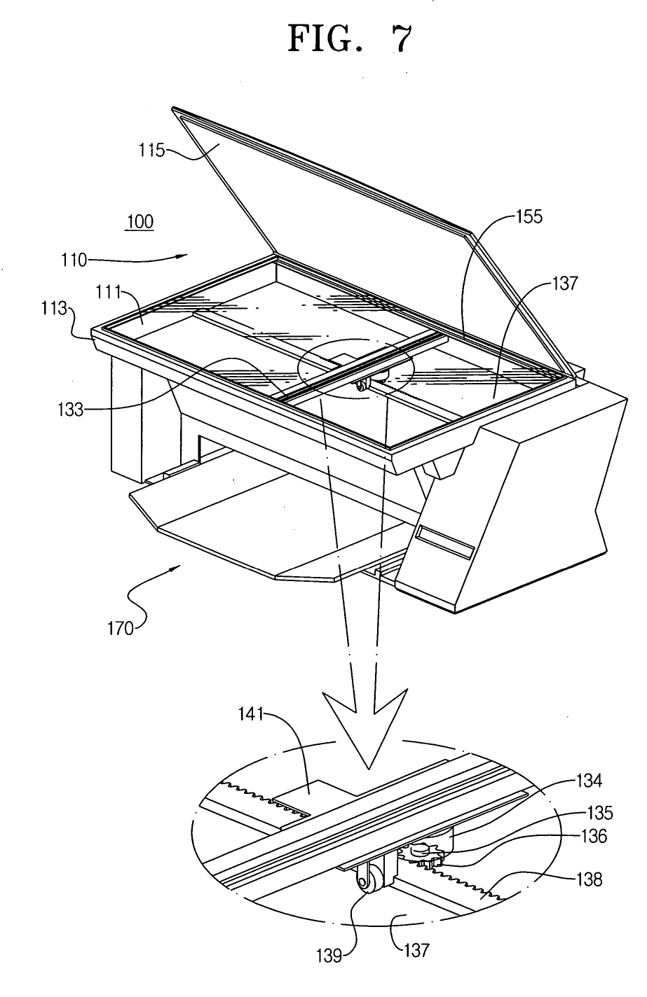

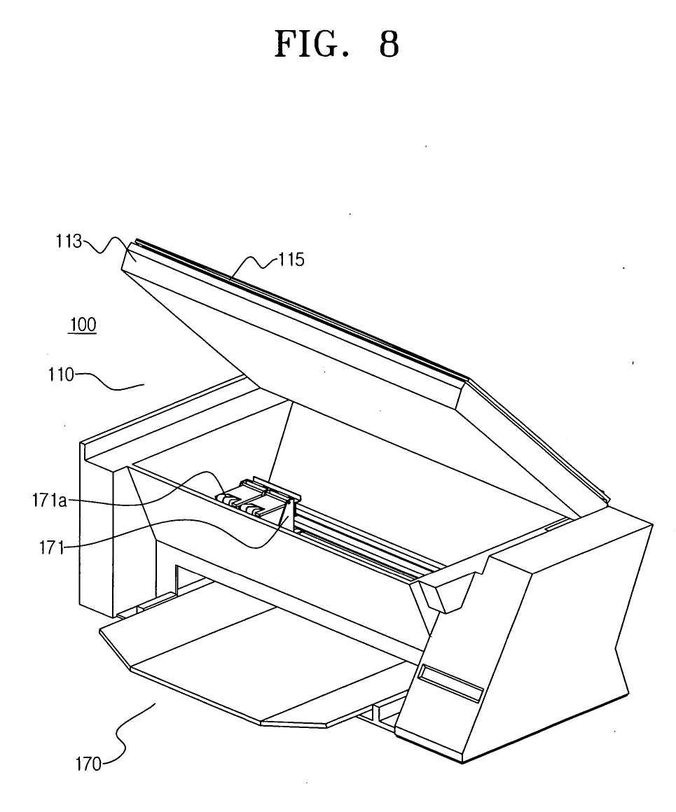

FIGS. 7 and 8 illustrate an exemplary ink-jet composite machine 100 having scanning and printing functions, in which a position control device is applied to the ink-jet composite machine 100 in accordance with an embodiment of the present invention.

The ink-jet composite machine 100 comprises a scanner unit 110 for scanning a document and a printer unit 170 for printing data on a paper (not shown).

The scanner unit 110 is a flat bed type scanner, which comprises a flat bed 113 having a glass plate 111, on which a document is laid, and a document cover 115 for securing the document laid on the glass plate 111.

A scanning module 133 for scanning the document is installed within the flat bed 113 below the glass plate 111.

A fixing plate 141 is installed below the scanning module 133, and a scanner motor 134 and a guide roller 139 are fixed on the fixing plate 141.

The scanner motor 134 drives the scanning module 133 forward and rearward when the document laid on the glass plate 111 is scanned, and the scanner motor 134 comprises a drive shaft 135 with a drive gear 136 provided at one end thereof. The drive gear 136 is meshed with a rack gear 138 provided on the bed frame 137.

The guide roller 139 guides the scanning module 133 to move along the bed frame 137 when the scanning module 133 is moved forward and rearward by the drive gear 136 meshed with the rack gear 138.

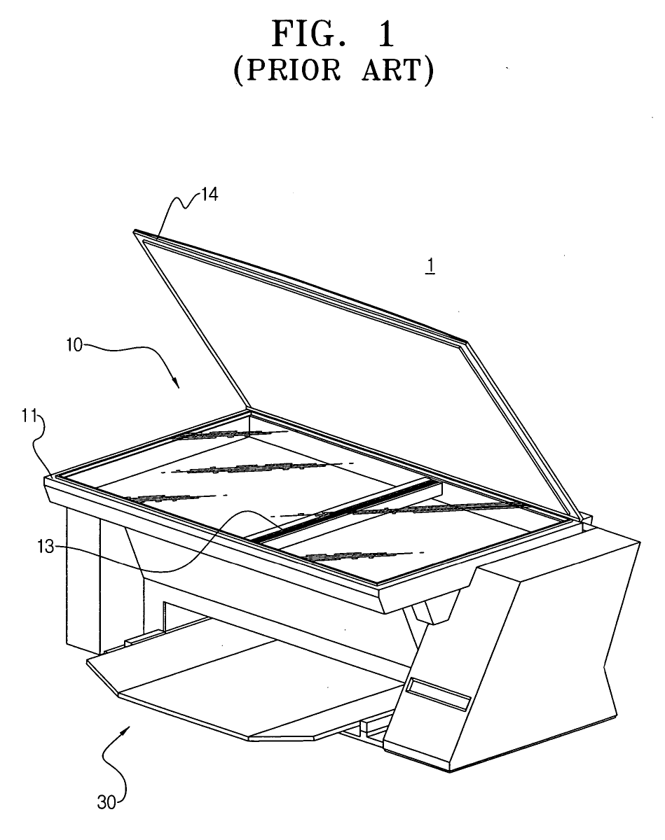

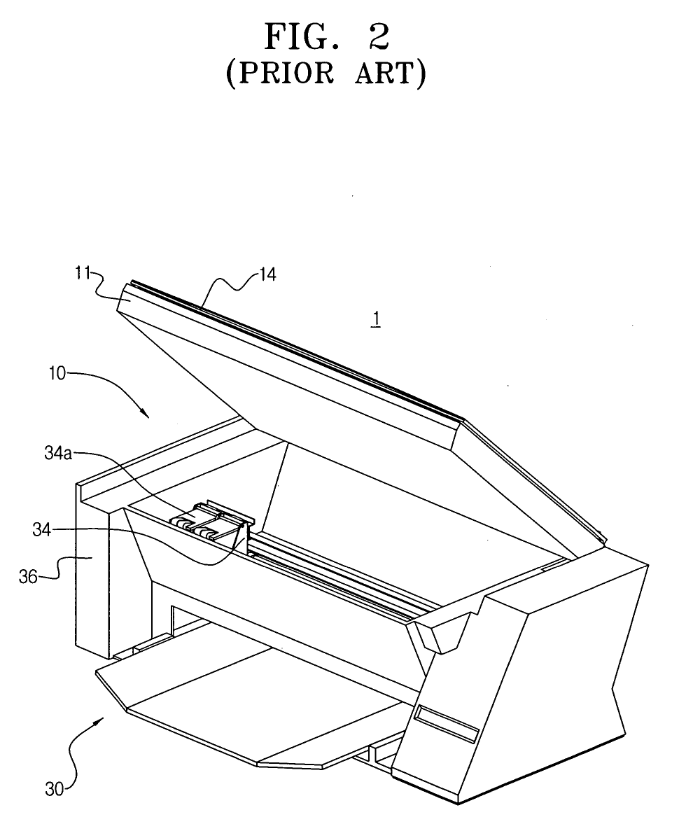

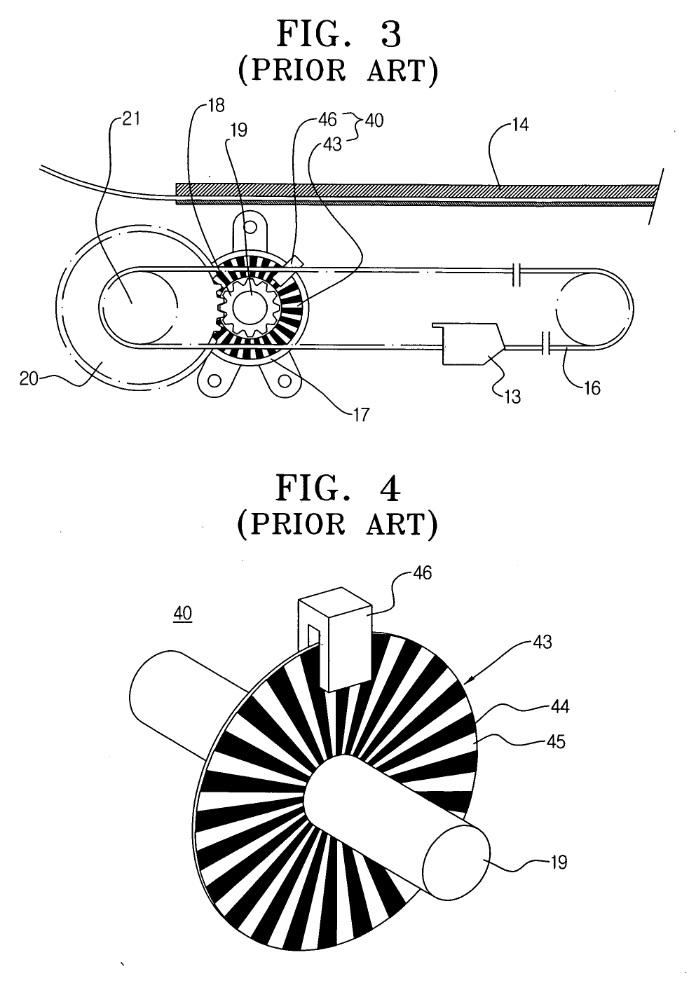

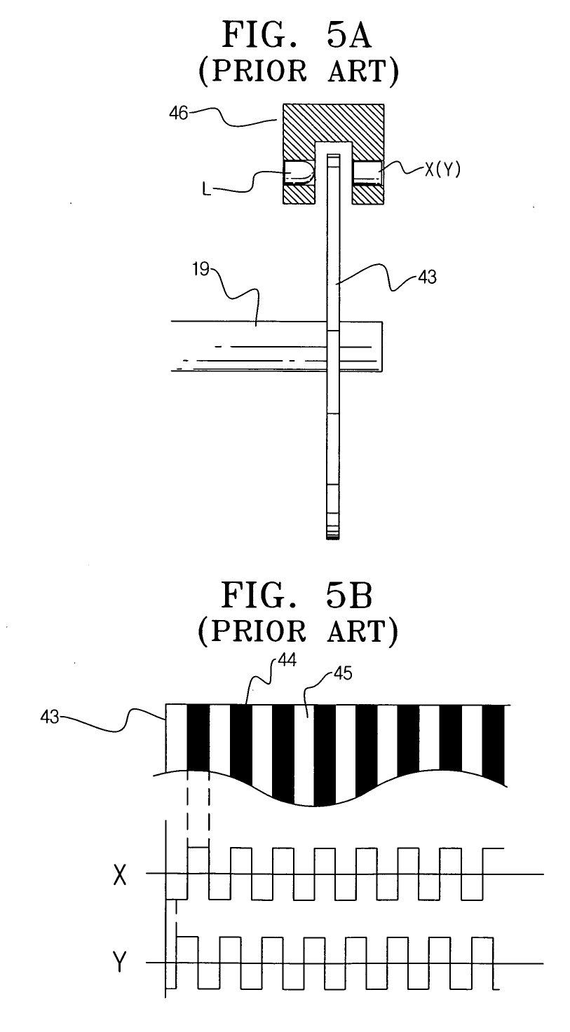

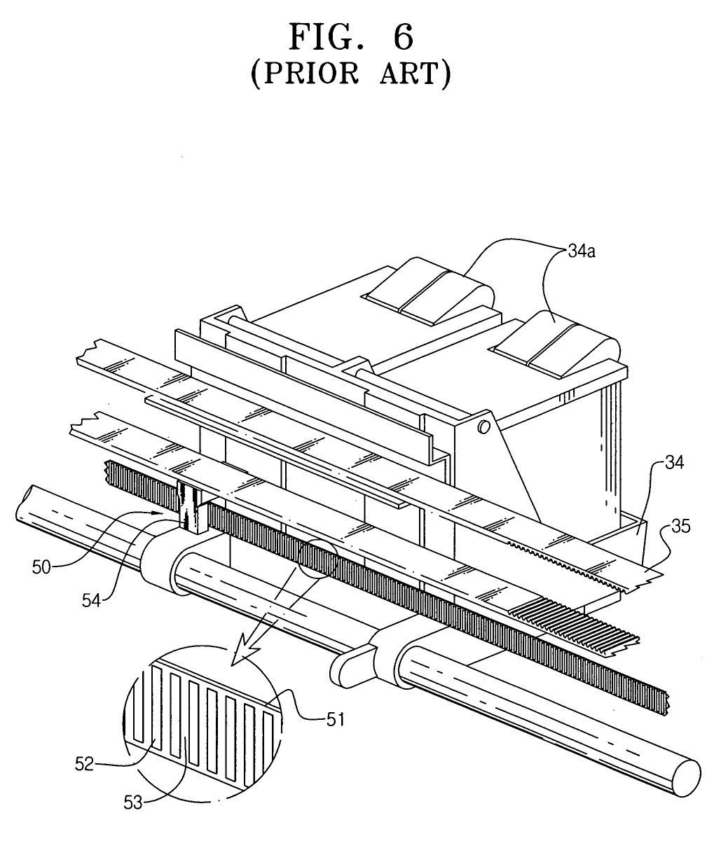

A lamp 142 for illuminating light on the document laid on the glass plate 111 is installed within the scanning module 133 as shown in FIG. 1. FIG. 11 is a cross-sectional view taken along line I-I of the scanner unit of the inkjet composite machine shown in FIG. 7. Referring to FIG. 11, a first mirror 143 for reflecting the light reflected from the surface of the document with recorded data is installed under the lamp 142, and is tilted to a predetermined angle.

At a side of the first mirror 143, a second mirror 144 is installed to reflect the light reflected by the first mirror 143 in a given angle toward a third mirror 145, wherein the third mirror 145 is located below the first mirror 143 to reflect the light from the second mirror 144 to a lens 146 for focusing the light. At a side of the lens 146, a CCD (charge coupled device) sensor 147 is disposed on a CCD board 148 for converting the focused light into an electric energy, that is, a voltage.

The scanner unit 110 further comprises a scanning module position control device 150 for controlling the position and conveying velocity of the scanning module 133.

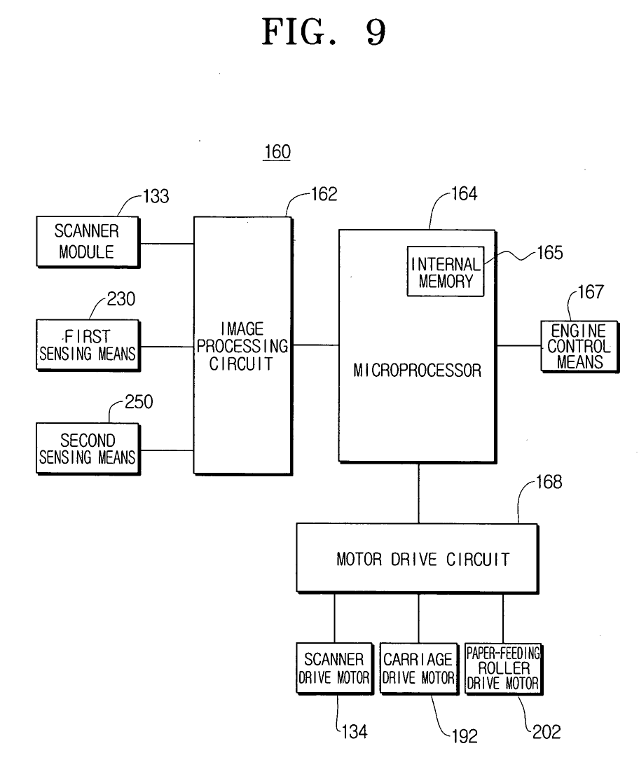

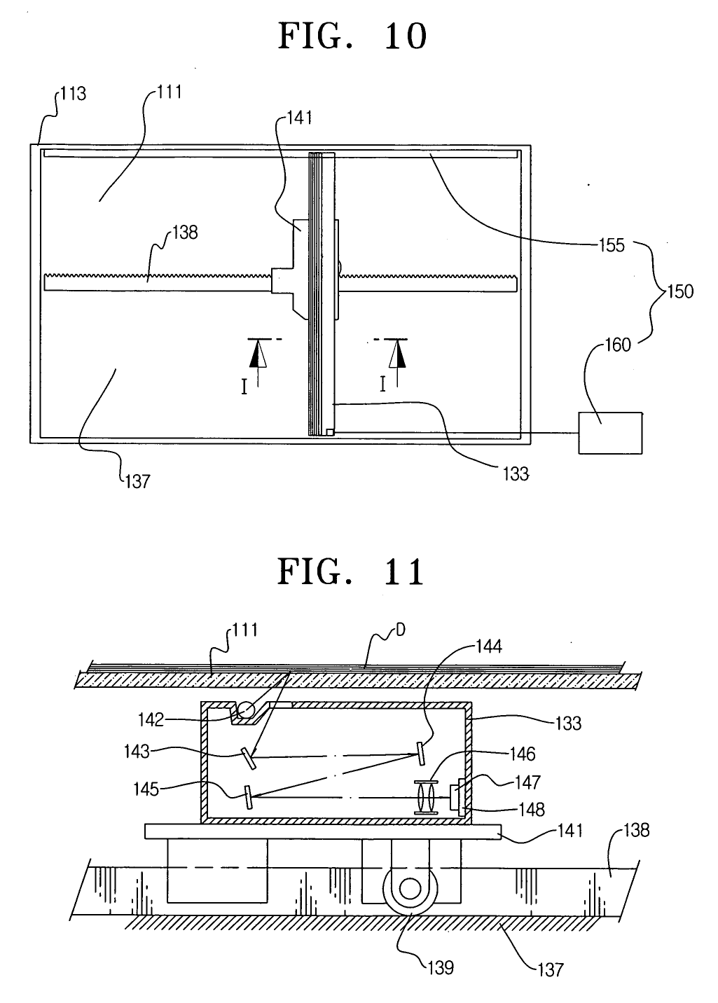

FIG. 10 is a top plan view of the exemplary scanner unit of the ink-jet composite machine shown in FIG. 7 in accordance with an embodiment of the present invention. As shown in FIG. 10, the scanning module position control device 150 comprises a first encoding means 155 and a control means 160.

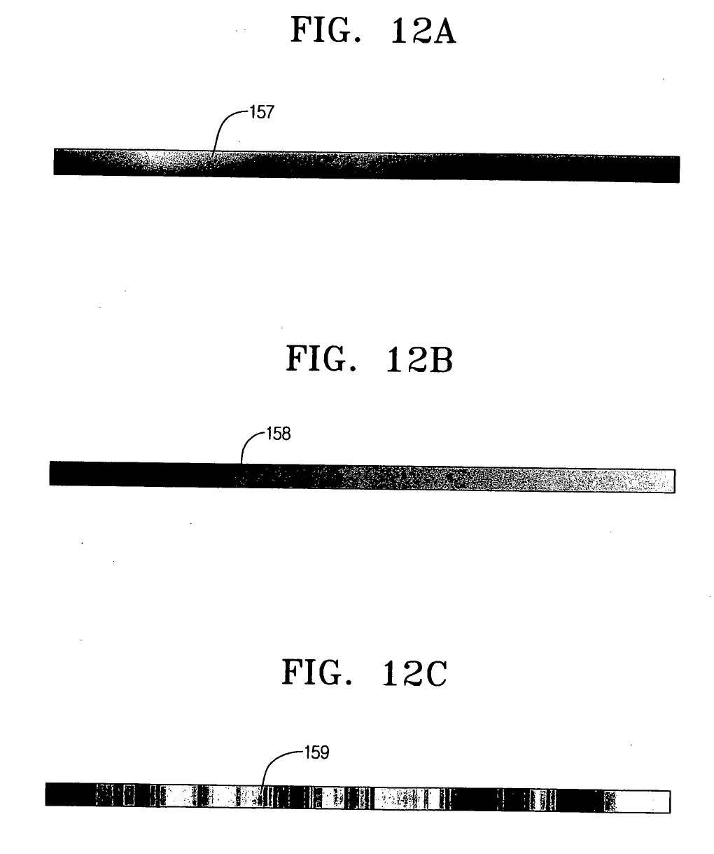

The first encoding means 155 is located under a side of the glass plate 111 along the moving path of the scanning module 133. The first encoding means 155 may comprise a linear strip with a color chart 157 (see FIG. 12A), on which chart colors are indicated on the surface thereof opposite to the scanning module 133.

FIGS. 12A, 12B and 12C are top plan views exemplifying examples of color charts of the first encoding means of the scanner module position control device of the scanner unit shown in FIG. 7 in accordance with an embodiment of the present invention. As shown in FIG. 12A, the color chart 157 of the linear strip is configured in a format in which plural colors are arranged in such a way that the colors are gradually changed in sequence. At this time, it is preferable that all of the colors in the color chart 157 are set to be different from each other. However, if the colors are set to be different from each other over the entire length of the color chart, it is difficult to fabricate the color chart because the number of the colors is too large. In such a case, it is possible to reduce the number of employed colors by arranging the colors in such a manner that a combination of several colors adjacent to one color is differentiated from a combination of several colors adjacent to another color next to the one color.

Alternatively, the color chart 157 can be configured in a format in which plural black-and-white based colors are gradually changed (as indicated by 158 in FIG. 12B) or in a format in which plural colors are each formed in a band shape and the bands are arranged in sequence (as indicated by 159 in FIG. 12C).

In particular, although the accuracy of controlling the position and conveying velocity can be enhanced if the inter-color interval is reduced, it is of little use if the scanning module 133 cannot detect respective colors. Therefore, it is preferable to set the number of colors and the inter-color interval within a range of resolution that allows the scanning module 133 to detect the respective colors. It is also possible to set the level in changes of colors to be different depending on the moving direction of the scanning module 133, that is, in the left and right directions, so that the moving direction of the scanning module 133 can be determined.

Returning to FIGS. 7 and 8, when conveyed by the drive gear 136 of the scanner motor 134, the scanning module 133 scans and detects not only the data of the document, but also the colors of the color chart 157 indicated on the linear strip of the first encoding means 155, and outputs document data and color data obtained by detecting the document and the colors of the color chart 157 to an image processing circuit 162 of the control means 160 which is described in greater detail below.

FIG. 9 is a block diagram of an exemplary control means of the ink-jet composite machine shown in FIG. 7 in accordance with an embodiment of the present invention. As shown in FIG. 9, the control means 160 comprises a circuit board, on which an image processing circuit 162, a microprocessor 164, and a motor drive circuit 168 are integrated.

The image processing circuit 162 converts the document data obtained from the document and the color data obtained from the color chart 157 by the scanning module 133 into R,G,B values having, for example, 24 bits per unit cell, that is, from black ((R, G, B)=(0, 0, 0)) to white ((R, G, B)=(255, 255, 255)) and outputs the R,G,B values of the converted document data and color data to the microprocessor 164.

Among the R,G,B values output from the image processing circuit 162, the microprocessor 164 stores the R,G,B values of the document data in its internal memory 165 or outputs the R,G,B values of the document data to the engine control means 167 of the printer unit 170 to proceed with printing. The microprocessor 164 also receives the R,G,B values of the color data obtained from the color chart 157 and compares the R,G,B values of respective colors or combinations of R,G,B values for several adjacent colors, with R,G,B values for respective colors each corresponding to an absolute position of the scanning module and previously stored in the internal memory 165, thereby determining the position of the scanning module 133. Here, the R,G,B values for respective colors each corresponding to an absolute position of the scanning module 133 are those determined and stored in the internal memory at the time of manufacturing the composite machine in such a manner that, at the time of manufacturing the composite machine, the scanning module 133 is rendered to scan a color of the color chart 157, then the scanned color data is converted into an R,G,B value by the image processing circuit 162, and then the microprocessor 164 determines and stores the converted R,G,B value as an absolute position of the scanning module 133 corresponding to the detected color.

In addition, the microprocessor 164 determines the conveying velocity of the scanning module 133 on the basis of a time interval in changes of R,G,B values for respective colors output from the image processing circuit 162.

Furthermore, the microprocessor 164 determines the moving direction of the scanning module 133 on the basis of a level or slope of changes of R,G,B values for respective colors output from the image processing circuit 162.

Depending on the absolute position, velocity and moving direction of the scanning module 133 determined thereby, the microprocessor 164 outputs control signals to the motor drive circuit 168 so that the scanning module 133 is moved to a position required for performing scanning, with a velocity suitable for performing scanning, and in a direction required for performing scanning.

The motor drive circuit 168 controls the driving of the scanner motor 134 by controlling the voltage applied to the scanner motor 134 according to the control signals supplied from the microprocessor 164.

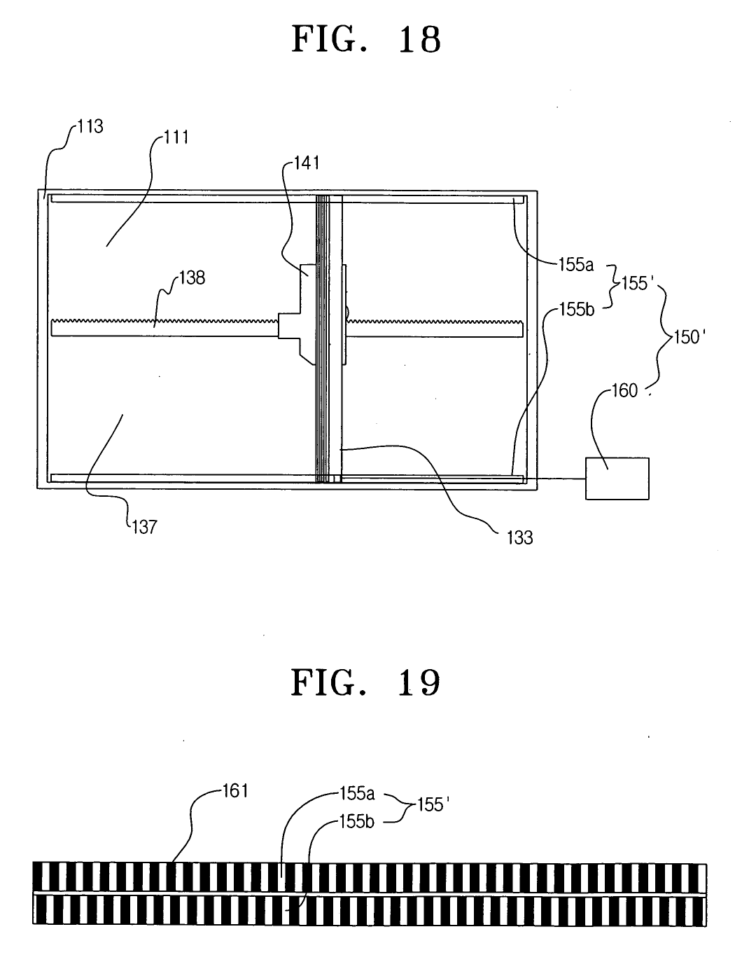

FIG. 18 is a top plan view exemplifying another example of the first encoding means of the scanner module position control device of the scanner unit shown in FIG. 7 in accordance with an embodiment of the present invention. That is, FIG. 18 shows another embodiment of the scanning module position control device 150′.

Referring to FIG. 18, the scanning module position control device 150′ comprises a first encoding means 155′, and a control means 160. The first encoding means 155′ comprises first and second linear strips 155a and 155b located under the opposite sides of the glass plate 111 along a conveying path of the scanning module 133. Each of the first and second linear strips 155a and 155b is provided with black bars 161 arranged at a regular interval on the surface thereof opposite to the scanning module 133. FIG. 19 is a top plan view exemplifying forms of the first and second linear strips of the first encoding means shown in FIG. 18 in accordance with an embodiment of the present invention. As shown in FIG. 19, the black bars 161 of the first and second linear strips 155a and 155b are arranged to deviate from each other with a phase difference of 90 degrees so that the conveying direction of the scanning module 133 can be determined.

In this event, the microprocessor 164 of the control means 160 counts the number and time interval of the black bars 161, which are input after being detected by the scanning module 133 and converted into R,G,B values through the image processing circuit 162, thereby determining the position and moving velocity of the scanning module 133 and controlling the driving of the scanner motor 134 by controlling the motor drive circuit 168 on the basis of the determined position and moving velocity.

In addition, the microprocessor 164 determines which one of either the black bars 161 of the first linear strip 155a or the black bars 161 of the second linear strip 155b are detected first, thereby determining the moving direction of the scanning module 133.

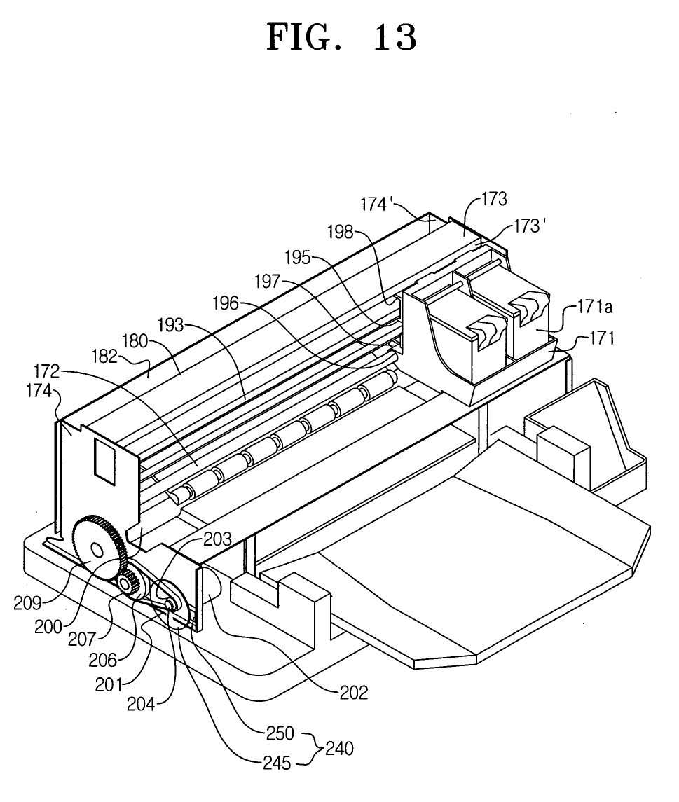

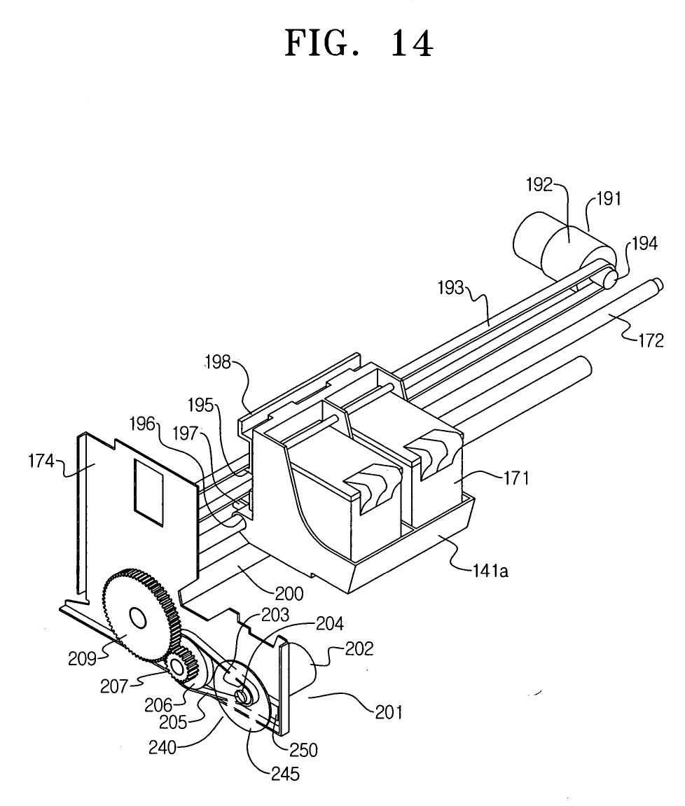

As shown in FIGS. 8 and 13, the printer unit 170 comprises a carriage 171, on which at least one ink cartridge 171a having a print head with a nozzle for ejecting ink is mounted, a carriage shaft 172 and a guide rail 173 for guiding the movement of the carriage 171, a chassis 180 having side supporting frames 174 and 174′ for supporting the carriage shaft 172 and the guide rail 173, a carriage drive means 191 (see FIG. 14) for moving the carriage 171 left and right along the carriage shaft 172, and a paper-feeding roller drive means 201 for driving a paper-feeding roller 200 for feeding a paper to be printed.

The carriage 171 has a guide slider 198 formed on a rear surface of an upper portion thereof to move left and right while coming in contact with a vertical wall 173′ of the guide rail 173, and a support bracket 196 for receiving and movably supporting the carriage shaft 172. FIG. 14 is a perspective view of an exemplary carriage drive means and paper-feeding roller drive means of the printer unit shown in FIG. 13 in accordance with an embodiment of the present invention. As shown in FIG. 14, the carriage drive means 191 comprises a carriage driving motor 192 fixed to the rear frame 182 of the chassis 180, and a carriage conveying belt 193 connected with the drive gear 194 of the carriage driving motor 192, in which the carriage conveying belt 193 transmits the power of the carriage driving motor 192 to a power transmission gear 195 formed on the rear side of the carriage 171 to convey the carriage 171 left and right.

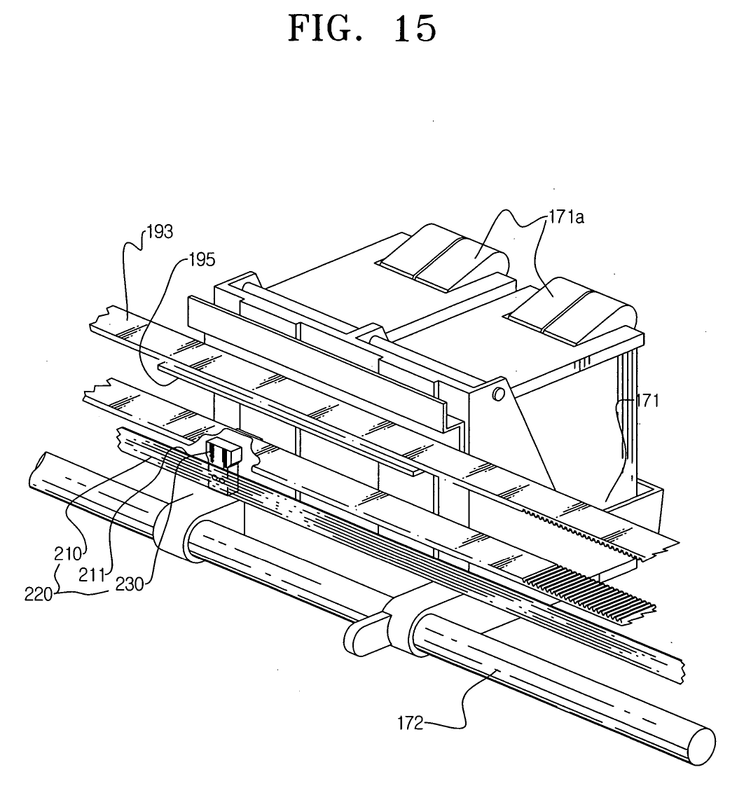

FIG. 15 is a partial perspective view illustrating an exemplary print head position control device of the printer unit shown in FIG. 13 in accordance with an embodiment of the present invention. As shown in FIG. 15, the printer unit 170 further comprises a print head position control device 220 for controlling the position and conveying velocity of the print head of the ink cartridge 171 a mounted on the carriage 171.

The print head position control device 220 comprises a second encoding means 210 and a first sensing means 230.

The second encoding means 210 is extended along the moving path of the carriage 171 to face the first sensing means 230, and the opposite ends of the second encoding means 210 are secured to the side supporting frames 174 and 174′. The second encoding means 210 comprises a linear strip 211 having a color chart with colors on its surface opposite to the first sensing means 230.

Like the linear strip of the first encoding means 155 described with reference to FIG. 12A, the color chart of the linear strip 211 is configured in a format in which plural colors are arranged in such a manner that the colors are gradually changed in sequence (not shown). Here, although all of the colors on the color chart can be different from each other, it is possible to arrange the colors in such a way that a combination of several colors adjacent to one color is differentiated from a combination of several colors adjacent to another color positioned next to the one color.

Alternatively, the color chart of the linear strip 211 may be configured in a format in which plural black-and-white based colors are gradually changed in sequence (not shown) or in a format in which plural colors are each formed in a band shape and the bands are arranged in sequence (not shown) like the linear strip of the first encoding means 155 described above with reference to FIGS. 12B and 12C.

In particular, it is preferable that the inter-color interval, that is, the time interval in changes of R,G,B values for respective colors, is set within a range of resolution that allows the first sensing means 230 to detect the respective colors. It is also preferable that the level in changes of colors, that is, the level in changes of R,G,B values for the respective colors are differently set depending on the moving direction of the carriage 171, that is, in the left and right directions, so that the moving direction of the first sensing means 230 and hence the carriage 171, can be determined.

The first sensing means 230 is fixed to the rear side of the carriage 171 to face the linear strip 211.

The first sensing means 230 comprises a color sensor. The color sensor detects the colors of the color chart on the linear strip 211, wherein the color sensor comprises a photo-reflector type sensor comprising a light emission part, such as an R, G or B LED, for emitting light to the color chart on the linear strip 211, and a light reception part, such as a photocell, for detecting the light reflected from the color chart. Alternatively, the first sensing means may comprise an image sensor having a light emission part, such as an R, G or B LED, a lens for focusing the light reflected from the color chart, and a light reception part, such as a photodiode for detecting the light focused by the lens, so as to increase the range for sensing colors, that is, so as to increase the number of colors detectable by the first sensing means 230 and to reduce the inter-color interval that allows the first sensing means 230 to detect the colors.

When the carriage 171 is conveyed by the carriage conveying belt 193, which receives power from the carriage motor 192, the first sensing means 230 detects a color on the color chart on the linear strip 211 and transmits data corresponding to the detected color to the image processing circuit 162 of the control means 160.

The image processing circuit 162 converts the color data detected by the sensing means 230 into an R,G,B value and outputs the converted R,G,B value of each color to the microprocessor 164.

The microprocessor 164 compares the R,G,B values of respective colors or combinations of the R,G,B values of several adjacent colors output from the image processing circuit 162, with the R,G,B values for colors each corresponding to an absolute position of the print head and previously stored in the internal memory 165, thereby determining the position of the print head. Here, the R,G,B values for respective colors each corresponding to an absolute position of the print head are those determined and stored in the internal memory at the time of manufacturing the composite machine in such a manner that, at the time of manufacturing the composite machine, the first sensing means 230 is rendered to detect a color on the color chart of the linear strip 211, then the detected color data is converted into an R,G,B value by the image processing circuit 162, and then the microprocessor 164 determines the converted R,G,B value as an absolute position of the scanning module 133 corresponding to the detected color.

The microprocessor 164 determines the conveying velocity of the print head on the basis of a time interval in changes of R,G,B values for respective colors, which are output from the image processing circuit 162.

In addition, the microprocessor 164 determines the moving direction of the print head on the basis of a level or slope in changes of R,G,B values for respective colors, which are output from the image processing circuit 162.

According to the position, velocity and moving direction determined thereby, the microprocessor 164 outputs control signals to the motor drive circuit 168 so that the print head can be made to move to a position required for performing printing, with a velocity suitable for performing printing, and in a moving direction required for performing printing. The motor drive circuit 168 controls the voltage applied to the carriage motor 192 according to the control signals from the microprocessor 164, thereby controlling the driving of the carriage motor 192.

As shown in FIGS. 13 and 14, the paper-feeding roller drive means 201 comprises a paper-feeding roller drive motor 202 fixed to the lower part of the side supporting frame 174, a power transmission pulley 206 having a power transmission gear 207, in which the power transmission pulley 206 is connected to a drive pulley 203 of the paper-feeding roller drive motor 202 through a power transmission belt 205, and a paper-feeding roller drive gear 209 formed coaxial to the paper feeding roller 200 and meshed with the power transmission gear 207.

The printer unit 170 further comprises a paper-feeding roller position control device 240 for controlling the rotating velocity of the paper-feeding roller 200.

The paper-feeding roller position control device 240 comprises a third encoding means 245 and second sensing means 250.

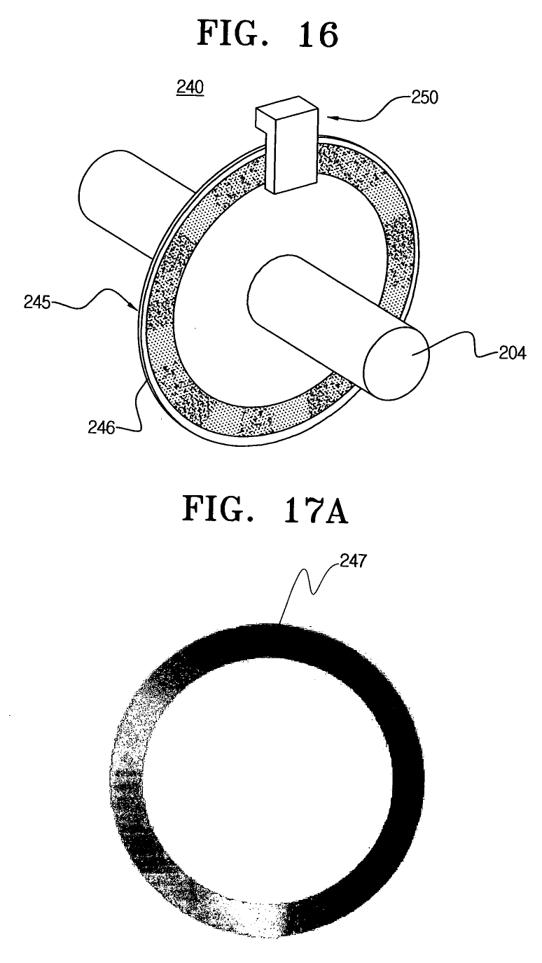

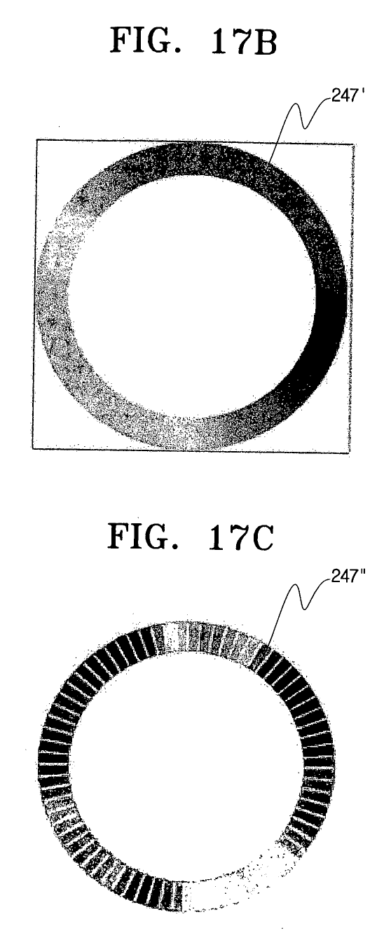

FIG. 16 is a partial perspective view illustrating exemplary embodiments of the second sensing means and the third encoding means of the paper-feeding roller position control device of the printer unit shown in FIG. 13. As shown in FIG. 16, the second encoding means 245 comprises a circular plate 246, in which the circular plate 246 is provided with a color chart on a surface opposite to the second sensing part 250 and wherein the colors are as indicated on the exemplary color chart 247 shown in FIG. 17. The third encoding means 245 is mounted on the drive shaft 204 to be capable of rotating along with the drive shaft 204. Alternatively, the third encoding means 245 may be installed on the shaft of any of the power transmission gear 207 and the paper-feeding drive gear 209 which are driven by the drive motor 202.

FIGS. 17A, 17B, and 17C are top plan views exemplifying color charts of the third encoding means of the paper-feeding roller position control device shown in FIG. 16 in accordance with an embodiment of the present invention. As shown in FIG. 17A, the color chart 247 of the circular plate 246 may be configured in a format in which plural colors are arranged in such a way that the colors are gradually changed in sequence. In this event, although it is preferable to set all the colors to be different from each other, it is possible to arrange the colors in such a way that a combination of several colors adjacent to one color is differentiated from a combination of several colors adjacent to another color next to the one color.

Alternatively, as shown in FIGS. 17B and 17C, the color chart may be configured in a format 247′ in which plural black-and-white based colors are gradually changed in sequence substantially similar to the colors of FIG. 12B, or in a format 247″ in which plural colors are each formed in a band shape and the bands are arranged in sequence substantially similar to the colors of FIG. 12C.

In particular, it is preferable to set the inter-color interval, that is, the time interval in changes of RGB values for respective colors within a range of resolution that allows the second sensing means 250 to detect the respective colors. It is also preferable to set the level or slope in changes of colors, that is, the slope in changes of RGB values for the respective colors to be changed depending on the rotating direction of the circular plate 246, that is, depending on whether the circular plate 246 rotates clockwise or counterclockwise, so that the rotating direction of the circular plate 246 and hence the paper-feeding roller 200, can be determined.

The second sensing means 250 is fixed to the side frame 174 to face the circular plate 246.

Like the first sensing means 230, the second sensing means 250 may comprise a color sensor or an image sensor.

The second sensing means 250 senses the colors indicated on the color chart 247 of the circular plate 246 when the circular plate 246 is rotated by the paper-feeding roller drive motor 202 and then transmits the data of respective detected colors to the image processing circuit 162.

The image processing circuit 162 converts the data for the respective colors detected by the second sensing means 250 into R,G,B values and outputs the converted R,G,B values to the microprocessor 164.

The microprocessor 164 determines the revolution number and rotating velocity of the paper-feeding roller 200 on the basis of a time interval in changes of RGB values for the respective colors output from the image forming circuit 162.

In addition, the microprocessor 164 determines the rotating direction of the paper-feeding roller 200 depending on a slope in changes of R,G,B values for the respective colors output from the image forming circuit 162.

According to the rotating velocity and direction of the paper-feeding roller 200 determined thereby, the microprocessor 164 outputs control signals to the motor drive circuit 168 so that the paper-feeding roller 200 can be driven with a rotating velocity required for feeding a paper and in direction required for feeding the paper. The motor drive circuit 168 controls the output voltage based on the control signals from the microprocessor 164, thereby controlling the driving of the paper-feeding roller drive motor 202.

Exemplified and described above as an appliance to which an exemplary position control device can be applied in accordance with an embodiment of the present invention, the ink-jet composite machine 100 comprises the scanner module position control device 150 for controlling the position and conveying velocity of a scanner module 133 of a scanner unit 110, the print head position control device 220 for controlling the position and conveying velocity of a print head of a printer unit 170, and the paper-feeding roller position control device 240 for controlling the rotating velocity and direction of a paper-feeding roller 200. However, embodiments of the present invention are not limited thereto. For example, an exemplary position control device in accordance with an embodiment of the present invention can be employed to control only the position of a scanner module in a scanner using substantially the same construction and principle as described above.

Now, an exemplary scanning operation of the ink-jet composite machine 100 configured as described above will be described in accordance with an embodiment of the present invention.

First, the document cover 115 is lifted up and a document sheet is laid on the glass plate 111 of the flat bed 113.

Thereafter, if the scanning function is turned “ON”, the microprocessor 164 drives the scanner motor 134 through the motor drive circuit 168. As a result, the drive gear 136 rotates along the rack gear 138 by the rotating force of the scanner motor 134, and the scanning module 133 urged by the drive gear 136 reciprocates left and right along the rack gear 138.

In this event, the lamp 142 installed within the scanning module 133 illuminates light on the color chart 157 of the linear strip and the document, the light reflected from the surface of the document and the color chart 157 is incident on the first mirror 143, and the first mirror 143 reflects the light toward the second mirror 144 in a predetermined angle.

Then, the light reflected from the second mirror 144 is reflected toward the lens 146 by the third mirror 145, and the lens 146 focuses and transmits the reflected light toward the CCD sensor 147.

Upon receiving the focused light, the CCD board 148 of the CCD sensor 147 outputs data signals corresponding to the light to the image processing circuit 162 of the control means 160, and the image processing circuit 162 converts the input data into R,G,B values, which are output to the microprocessor 164.

Among the R,G,B values output from the image processing circuit 162, the R,G,B values of the document are stored in the internal memory 165 or output to the engine control means 167 of the printer unit 170 to proceed with printing by the microprocessor 164. For the R,G,B values of the colors of the color chart 157, the microprocessor 164 compares the R,G,B values of the respective colors or combinations of R,G,B values for several adjacent colors, with the R,G,B values of respective colors each corresponding to an absolute position and previously stored in the internal memory 165, thereby determining the position of the scanning module 133.

In addition, the microprocessor 164 determines the velocity and the moving direction of the scanning module 133 on the basis of the time interval and level in changes of respective R,G,B values output from the image processing circuit 162.

According to the position, velocity and moving direction of the scanning module 133 determined thereby, the microprocessor 164 outputs control signals to the motor drive circuit 168 so that the scanning module 133 is moved to a position required for scanning the document, with a velocity suitable for scanning the document, and in a moving direction required for scanning the document.

Next, an exemplary printing operation of the ink-jet printer 100 is described in detail.

If a command for printing is rendered from a computer or the microprocessor 164, a paper is picked up from a paper-feeding tray or cassette by a pick-up roller (not shown) connected to the paper-feeding roller drive gear 209 of the paper-feeding roller drive means 201 through separate gearing (not shown) depending on the operation of the paper-feeding roller drive motor 202, which is controlled by the motor drive circuit 168.

The paper conveyed to the paper-feeding roller 200 is conveyed to the print head by a given amount of movement by the paper-feeding roller 200 connected to the drive gear 209 through the power transmission belt 205, the power transmission pulley 206, and the. power transmission gear 207, which transmit the power of the paper-feeding roller drive motor 202.

At this time, the second sensing means 250 detects the colors indicated on the color chart 247 of the circular plate 246 when the circular plate 246 is rotated by the paper-feeding roller drive motor 202, and transmits the data for the detected colors to the image processing circuit 162.

The image processing circuit 162 converts the data for respective colors detected by the second sensing means 250 into R,G,B values and outputs the R,G,B values converted thereby to the microprocessor 164.

The microprocessor 164 determines the rotating velocity and direction of the paper-feeding roller 200 on the basis of the time interval and slope in changes of the respective colors output from the image processing circuit 162.

According to the rotating velocity and direction of the paper-feeding roller 200 determined thereby, the microprocessor 164 controls the motor drive circuit 168 to drive the paper-feeding roller drive motor 202, so that the paper-feeding roller 200 is rotated with a rotating velocity required for conveying a paper and in a rotating direction required for conveying the paper.

Then, when the paper is passing underneath the print head by the paper-feeding roller 200, the print head ejects ink through a nozzle while being moved left and right along the carriage shaft 172 and the guide rail by the carriage 171 conveyed left and right through the drive gear 194, the carriage conveying belt 193, and the power transmission gear 195, which transmit the power of the carriage drive motor 192, thereby proceeding with printing.

At this time, the first sensing means 230 detects the colors from the color chart of the linear strip 211 when the carriage 171 is conveyed left and right, and the first sensing means 230 outputs the data corresponding to the detected colors to the image processing circuit 162.

The image processing circuit 162 converts the data of the colors detected by the first sensing means 230 into R,G,B values and outputs the R,G,B values to the microprocessor 164.

The microprocessor 164 compares the R,G,B values of the respective colors or combinations of R,G,B values of several colors, with the R,G,B values of colors each corresponding to an absolute position of the print head and previously stored in the internal memory 165, to thereby determine the position of the print head of the ink cartridge 171a mounted on the carriage 171, and determine the position, conveying velocity and moving direction of the print head on the basis of the time interval and slope in changes of respective R,G,B values output from the image processing circuit 162.

According to the position, conveying velocity and moving direction determined thereby, the microprocessor 164 outputs control signals to the motor drive circuit 168 so that the print head is moved with a velocity required for performing printing and in a moving direction required for performing printing, thereby controlling the driving of the carriage motor 192.

As described above, exemplary embodiments of a position control device, and a scanner and an image forming apparatus having the same, can control the velocity and position of a rotating body or a moving body substantially as accurately as the resolution of a sensing means for detecting colors, and can correctly control the velocity and position of the rotating body or the moving body even if the rotating body or the moving body slips, because the velocity and position of the rotating body or the moving body is controlled on the basis of values of plural colors detected by the sensing means.

In addition, exemplary embodiments of a position control device, and a scanner and an image forming apparatus having the same, can determine the position of the rotating body or the moving body on the basis of only one color. Therefore, when initializing the position of the rotating body or the moving body after a machine is turned “ON”, there is no longer a need to rotate or move the rotating body or the moving body along the entire conveying path for initialization, and as a result, it is possible to avoid the problem of delays in the printing time.

Although exemplary embodiments of the present invention have been shown and described in order to illustrate the present invention, the present invention is not limited to the specific embodiments. It will be understood that various modifications and changes can be made without departing from the spirit and scope of the present invention as defined by the appended claims. Therefore, it shall be considered that such modifications, changes and equivalents thereof are all included within the scope of the present invention.

What is claimed is:

1. A position control device for controlling the velocity and position of a rotating body or a moving body driven by a motor, wherein the position control device comprises:
an encoding means having a color chart on which colors are indicated;
a sensing means for detecting the colors indicated on the color chart; and
a control means for determining the velocity and position of the rotating body or the moving body and controlling the driving of the motor based on detected colors.

2. The position control device as claimed in claim 1, wherein the encoding means comprises at least one of a circular plate and a linear strip.

3. The position control device as claimed in claim 2, wherein the color chart is configured in at least one of:
a format in which plural colors are arranged in such a way that the colors are gradually changed in sequence; and
a format in which plural colors are each formed in a band shape and the bands are arranged in sequence.

4. The position control device as claimed in claim 3, wherein an interval between two adjacent colors is set within a range of resolution that allows the sensing means to detect each color.

5. The position control device as claimed in claim 1, wherein the sensing means comprises one of a color sensor and an image sensor.

6. The position control device as claimed in claim 1, wherein the sensing means comprises:
a lamp for illuminating light on the color chart of the encoding means;
at least one mirror for reflecting the light reflected from the color chart;
a lens for focusing the light reflected by the mirror; and
a charge coupled device (CCD) sensor for detecting light focused by the lens.

7. The position control device as claimed in claim 1, wherein the control means comprises:
an image processing circuit for converting a signal into a red, green and blue (R,G,B) value, in which the signal is generated when the sensing means detects a color;
a microprocessor for determining the velocity and position of the rotating body or the moving body corresponding to each color on the basis of the R,G,B values of respective colors converted by the image processing circuit; and
a motor drive circuit for controlling the motor under the control of the microprocessor.

8. A scanner, comprising:
a scanning module for scanning data from a document;
a motor for generating a drive force for conveying the scanning module; and
a scanning module position control means for controlling the conveying velocity and position of the scanning module, wherein the scanning module position control means comprises:
an encoding means arranged on a path for conveying the scanning module to face the scanning module and having a color chart on which colors are indicated; and
a control means for determining the conveying velocity and position of the scanning module on the basis of the data of colors detected by the scanning module when the scanning module is conveyed, and controlling the driving of the motor.

9. The scanner as claimed in claim 8, wherein the encoding means comprises at least one linear strip arranged along the moving path of the scanning module.

10. The scanner as claimed in claim 9, wherein the color chart is configured in at least one of a format in which plural colors are arranged in such a way that the colors are gradually changed in sequence, and in a format in which plural colors are each formed in a band shape and the bands are arranged in sequence.

11. The scanner as claimed in claim 10, wherein an interval between two adjacent colors is set within a range of resolution that allows the scanning module to detect respective colors.

12. The scanner as claimed in claim 8, wherein the scanning module comprises:
a lamp for illuminating light on the document and the color chart of the encoding means;
at least one mirror for reflecting the light reflected from the document and the color chart;
a lens for focusing the light reflected by the mirror; and
a charge coupled device (CCD) sensor for detecting light focused by the lens.

13. The scanner as claimed in claim 8, wherein the control means comprises:
an image processing circuit for converting a signal into a red, green and blue (R,G,B) value, in which the signal is generated when the sensing means detects a color;
a microprocessor for determining the conveying velocity and position of the scanning module corresponding to each color on the basis of the R,G,B values converted by the image processing circuit; and
a motor drive circuit for controlling the motor under the control of the microprocessor.

14. An image forming apparatus, comprising:
a carriage for conveying at least one ink cartridge mounted thereon and having a print head for printing an image on a paper;
a carriage driving means having a first motor for generating a driving force for conveying the carriage; and
a printer unit having a first position control means for controlling the conveying velocity and position of the print head of the ink cartridge mounted on the carriage conveyed by the first motor, wherein the first position control means comprises:
a second encoding means having a color chart on which colors are indicated;
a first sensing means for detecting the colors indicated on the color chart; and
a control means for determining the position and conveying velocity of the print head on the basis of the colors detected by the first sensing means and controlling the driving of the first motor.

15. The image forming apparatus as claimed in claim 14, wherein the second encoding means comprises a linear strip arranged on a frame along the conveying path of the carriage.

16. The image forming apparatus as claimed in claim 15, wherein the color chart of the second encoding means is configured in at least one of a format in which plural colors are arranged in such a way that the colors are gradually changed in sequence, and in a format in which plural colors are each formed in a band shape and the bands are arranged in sequence.

17. The image forming apparatus as claimed in claim 16, wherein an interval between two adjacent colors is set within a range of resolution that allows the first sensing means to detect each color.

18. The image forming apparatus as claimed in claim 14, wherein the first sensing means comprises one of a color sensor and an image sensor arranged on the carriage to face the second encoding means and to be moved along with the carriage.

19. The position control device as claimed in claim 14, wherein the control means comprises:
an image processing circuit for converting a signal into a red, green and blue (R,G,B) value, in which the signal is generated when the first sensing means detects a color;
a microprocessor for determining the conveying velocity and position of the print head corresponding to each color on the basis of the R,G,B values converted by the image processing circuit; and
a motor drive circuit for controlling the driving of the first motor under the control of the microprocessor.

20. The image forming apparatus as claimed in claim 14, wherein the printer unit further comprises:
at least one paper-feeding roller for conveying a paper;
a second motor for providing a driving force for driving the paper-feeding roller; and
a second position control means for controlling the rotating velocity of the second motor.

21. The image forming apparatus as claimed in claim 20, wherein the second position control means comprises:
a third encoding means having a color chart on which colors are indicated;
a second sensing means for detecting the colors indicated on the third encoding means; and
a control means for determining the rotating velocity of the paper-feeding roller on the basis of the colors detected by the second sensing means, and controlling the driving of the second motor.

22. The image forming apparatus as claimed in claim 21, wherein the third encoding means comprises a circular plate mounted on a drive shaft of the second motor or a shaft of a gear driven by the second motor.

23. The image forming apparatus as claimed in claim 21, wherein the color chart of the third encoding means is configured in at least one of a format in which plural colors are arranged in such a way that the colors are gradually changed in sequence, and in a format in which plural colors are each formed in a band shape and the bands are arranged in sequence.

24. The image forming apparatus as claimed in claim 23, wherein an interval between two adjacent colors is set within a range of resolution that allows the second sensing means to detect respective colors.

25. The image forming apparatus as claimed in claim 21, wherein the second sensing means comprises one of a color sensor and an image sensor mounted on a frame to face the third encoding means.

26. The image forming apparatus as claimed in claim 21, wherein the control means comprises:
an image processing circuit for converting a signal into a red, green and blue (R,G,B) value, in which the signal is generated when the second sensing means detects a color;
a microprocessor for determining the rotating velocity of the paper-feeding roller corresponding to each color on the basis of the R,G,B values calculated by the image processing circuit; and
a motor drive circuit for controlling the driving of the second motor under the control of the microprocessor.

27. The image forming apparatus as claimed in claim 14, further comprising a scanning unit for scanning data from a document, wherein the scanning unit comprises:
a scanning module for scanning data from the document;
a third motor for generating a driving force for conveying the scanning module; and
a third position control means for controlling the conveying velocity and position of the scanning module, and wherein the third position control means comprises:
a first encoding means arranged on the conveying path of the scanning module to face the scanning module and having a color chart on which colors are indicated; and
a control means for determining the conveying velocity and position of the scanning module on the basis of the data of the colors on the color chart detected by the scanning module when the scanning module is conveyed, and controlling the driving of the third motor.

28. The image forming apparatus as claimed in claim 27, wherein the first encoding means comprises at least one strip arranged along the moving path of the scanning module.

29. The image forming apparatus as claimed in claim 28, wherein the color chart of the first encoding means is configured in at least one of a format in which plural colors are arranged in such a way that the colors are gradually changed in sequence, and in a format in which plural colors are each formed in a band and the bands are arranged in sequence.

30. The image forming apparatus as claimed in claim 29, wherein an interval between two adjacent colors is set within a range of resolution that allows the scanning module to detect respective colors.

31. The image forming apparatus as claimed in claim 27, wherein the scanning module comprises:
a lamp for illuminating light on a document and the color chart of the first encoding means;
at least one mirror for reflecting the light reflected from the document and the color chart;
a lens for focusing the light reflected by the mirror; and
a charge coupled device (CCD) sensor for detecting light focused by the lens.

32. The image forming apparatus as claimed in claim 27, wherein the control means comprises:
an image processing circuit for converting a signal into a red, green and blue (R,G,B) value, in which the signal is generated when the scanning module detects a color;
a microprocessor for determining the conveying velocity and position of the scanning module corresponding to respective colors on the basis of the R,G,B values converted by the image processing circuit; and
a motor drive circuit for controlling the third motor under the control of the microprocessor.
